(19) United States
(12) Patent Application Publication
(10) Pub. No.: US 2011/0040556 A1
(43) Pub. Date: Feb. 17, 2011

(54) METHOD AND APPARATUS FOR ENCODING AND DECODING RESIDUAL SIGNAL

(75) Inventors: Han-gil MOON, Seoul (KR); Chul-woo LEE, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/839,751

(22) Filed: Jul. 20, 2010

(30) Foreign Application Priority Data
Aug. 17, 2009 (KR) 10-2009-0075735

(51) Int. Cl. G10L 19/14

(52) U.S. Cl. 704/205; 704/E19.039

(57) ABSTRACT

A method and apparatus for encoding and decoding a residual signal are provided. The encoding method includes generating a residual signal indicating a difference between a multi-channel audio signal, and an audio signal downmixed from the multi-channel audio signal and then upmixed by using additional information from the downmixed audio signal; and performing a parametric encoding method on the residual signal. The decoding method includes decoding a sinusoidal component; restoring a sine wave by using the sinusoidal component; dividing the sine wave into a plurality of sub-bands in a frequency domain; transforming the plurality of sub-bands from the frequency domain into a time domain by applying a window to each of the plurality of sub-bands; and synthesizing the plurality of domain-transformed sub-bands to restore a residual signal.

### CROSS-REFERENCE TO RELATED PATENT APPLICATION

This application claims priority from of Korean Patent Application No. 10-2009-0075735, filed on Aug. 17, 2009, in the Korean Intellectual Property Office, the disclosure of which is incorporated by reference herein in its entirety.

### BACKGROUND

1. Field

Exemplary embodiments relate to a method and apparatus for encoding and decoding a residual signal, and more particularly, to a method and apparatus for applying a parametric encoding method to a residual signal in an audio signal coding operation.

2. Description of the Related Art

Many high quality audio coding apparatuses use a time-frequency transform coding method. The time-frequency transform coding method involves encoding a coefficient that is obtained by transforming an audio signal into the frequency domain. For example, the audio signal is input and transformed using a transform such as a modified discrete cosine transform (MDCT) into the frequency domain. However, the time-frequency transform coding method has a disadvantage in that the lower the target bit rate is, the lower the sound quality is, thus making it difficult to encode an audio signal using a low bit rate.

In general, if an original audio signal is downmixed to generate a mono or stereo signal and then the downmixed signal is restored by upmixing, the restored audio signal is different from the original audio signal. In this regard, a signal indicating a difference between the original audio signal before downmixing and the audio signal that is downmixed and then restored by being upmixed is called a residual signal.

### SUMMARY

Exemplary embodiments provide a method and apparatus for applying a parametric encoding method to a residual signal in an audio signal coding operation.

Exemplary embodiments also provide a method and apparatus for performing a parametric encoding method by applying a transient signal window to a period in which a transient signal in a residual signal is generated.

According to an aspect, there is provided a residual signal encoding method including obtaining a residual signal indicating a difference between a multi-channel audio signal, and an audio signal that has been downmixed from the multi-channel audio signal and then upmixed by using additional information from the downmixed audio signal; and performing a parametric encoding method on the residual signal.

The operation of performing the parametric encoding method may include analyzing the residual signal and obtaining a sinusoidal component; and encoding the sinusoidal component. Also, the operation of obtaining the sinusoidal component may include transforming the residual signal into a frequency domain and dividing the residual signal into a plurality of sub-bands; and obtaining the sinusoidal component with respect to the residual signal in the frequency domain.

The residual signal encoding method may further include detecting whether a sub-band including a transient signal exists in the plurality of sub-bands; and if the sub-band including the transient signal exists, generating information for identifying the sub-band including the transient signal.

According to another aspect, there is provided a residual signal decoding method including decoding a sinusoidal component; restoring a sine wave by using the sinusoidal component; dividing the sine wave into a plurality of sub-bands in a frequency domain; transforming the sub-bands from the frequency domain into the time domain by applying a window to each of the plurality of sub-bands; and restoring a residual signal by synthesizing signals of the plurality of domain-transformed sub-bands.

The operation of transforming the frequency domain into the time domain may include applying a transient signal window to a sub-band including a transient signal. Also, the operation of transforming the frequency domain into the time domain may include t identifying the sub-band including the transient signal by using information indicating the sub-band including the transient signal. Also, the sinusoidal component may include one or more of an amplitude, a phase, and a frequency of the sine wave.

According to another aspect, there is provided a residual signal encoding apparatus including a residual signal generating unit which obtains a residual signal indicating a difference between a multi-channel audio signal, and an audio signal that has been downmixed from the multi-channel audio signal and then upmixed by using additional information from the downmixed audio signal; and a residual signal encoding unit which performs a parametric encoding method on the residual signal.

According to another aspect, there is provided a residual signal decoding apparatus including a sine wave restoring unit which decodes a sinusoidal component and restores a sine wave by using the sinusoidal component; a band dividing unit which divides the sine wave into a plurality of sub-bands in a frequency domain; an inverse-transform unit which transforms the sub-bands from the frequency domain into the time domain by applying a window to each of the plurality of sub-bands; and a synthesizing unit which restores a residual signal by synthesizing signals of the plurality of domain-transformed sub-bands.

According to another aspect, there is provided a computer readable recording medium having recorded thereon a program for executing a residual signal encoding method including obtaining a residual signal indicating a difference between a multi-channel audio signal, and an audio signal that has been downmixed from the multi-channel audio signal and then upmixed by using additional information from the downmixed audio signal; and performing a parametric encoding method on the residual signal.

According to another aspect, there is provided a computer readable recording medium having recorded thereon a program for executing a residual signal decoding method including decoding a sinusoidal component; restoring a sine wave by using the sinusoidal component; dividing the sine wave into a plurality of sub-bands in a frequency domain; transforming the side-bands from the frequency domain into the time domain by applying a window to each of the plurality of sub-bands; and restoring a residual signal by synthesizing signals of the plurality of domain-transformed sub-bands.

According to another aspect, there is provided a method and apparatus for applying a parametric encoding method to a residual signal in an audio signal coding operation.

According to another aspect, there is provided a method and apparatus for performing a parametric encoding method by applying a transient signal window to a period in which a transient signal in a residual signal is generated.

### BRIEF DESCRIPTION OF THE DRAWINGS

The above and other aspects of the exemplary embodiments will become more apparent by describing in detail the exemplary embodiments thereof with reference to the attached drawings in which:

FIG. 1 is an internal block diagram of a residual signal processing device according to an exemplary embodiment;

FIG. 2 is an internal block diagram of a residual signal encoding unit of the residual signal processing device of FIG. 1;

FIG. 3 is a block diagram of an audio signal decoding apparatus according to another exemplary embodiment;

FIG. 4 is an internal block diagram of a residual signal decoding unit of the audio signal decoding apparatus of FIG. 3;

FIG. 5 is a diagram of a transient signal window according to another exemplary embodiment;

FIGS. 6A through D are diagrams illustrating an example of a case in which a pre-eco does not occur when a domain-transform is performed by applying a transient signal window, according to an exemplary embodiment; and

FIG. 7 is a flowchart of a residual signal decoding method, according an exemplary embodiment.

### DETAILED DESCRIPTION

Hereinafter, exemplary embodiments will be described in detail with reference to the attached drawings.

It is possible to encode an audio signal according to a low bit rate using a parametric encoding method. Examples of the parametric encoding method include a Harmonic and Individual Lines plus Noise (HINL) method, or a Sinusoidal Coding (SSC) method, or the like. The parametric encoding method involves modeling an original audio signal as being formed of component signals having specific characteristics, detecting the component signals from the original audio signal, and encoding parameters indicating the characteristics of the detected component signals. For example, if an audio signal is formed of a plurality of sinusoidal waves, the SSC method detects the sinusoidal waves from the audio signal and encodes a frequency, a phase, and an amplitude of the detected sinusoidal waves.

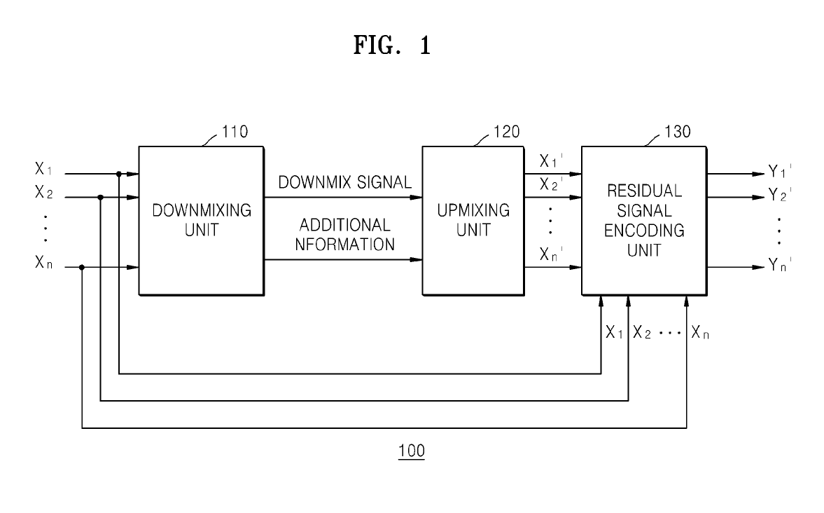

FIG. 1 is a block diagram of a residual signal processing device 100 according to an exemplary embodiment. The residual signal processing device 100 includes a downmixing unit 110, an upmixing unit 120, and a residual signal encoding unit 130.

An audio signal encoding apparatus (not shown) generates a mono or stereo signal by downmixing an original multi-channel audio signal, and encoding the mono or stereo signal.

The residual signal processing device 100 may be a part of an audio signal encoding apparatus or may be provided as a stand-alone unit separate from the audio signal encoding apparatus.

An audio signal decoding apparatus (not shown) decodes the encoded audio signal transmitted from the audio signal encoding apparatus, and restores a multi-channel audio signal by upmixing the decoded audio signal. Accordingly, a difference may occur between the multi-channel audio signal that is restored by the audio signal decoding apparatus and the original multi-channel audio signal before being encoded by the audio signal encoding apparatus.

In order to prevent this difference, the audio signal encoding apparatus restores the multi-channel audio signal by upmixing the downmixed audio signal in the same manner as the audio signal decoding apparatus does, obtains a difference signal indicating a difference between the restored multi-channel audio signal and the original multi-channel audio signal, and then transmits the difference signal to the audio signal decoding apparatus. In this manner, a signal indicating a difference between an original audio signal before being downmixed and an audio signal restored by upmixing again the downmixed original audio signal is called a residual signal.

The downmixing unit 110 downmixes an audio signal formed of n multi channels, and generates a mono or stereo downmixed signal. However, the downmixed signal may not be generated by the downmixing unit 110 but may be artificially generated and then provided to the upmixing unit 120. The downmix signal is encoded by a downmix signal encoding unit (not shown) and transmitted to the audio signal decoding apparatus.

The downmixing unit 110 generates additional information indicating a relation between the n multi channels of the audio signal while downmixing the audio signal. The additional information may include channel level differences (CLD) that indicate an energy difference between channels, interchannel correlations (ICC) that indicate a closeness or a similarity between the channels, or channel prediction coefficients (CPC) that indicate coefficients that are used to predict audio signal values by using other signals. The additional information is encoded by an additional information encoding unit (not shown) and transmitted along with or separately from the encoded downmixed signal to the audio signal decoding apparatus.

The upmixing unit 120 applies the additional information to the audio signal that is downmixed by the downmixing unit 110, and restores the audio signal formed of the n multi-channel.

The residual signal encoding unit 130 obtains a difference between the audio signal that is restored by the upmixing unit 120 and the original audio signal that is input to the downmixing unit 110, and generates a residual signal. The residual signal encoding unit 130 performs a parametric encoding method on the residual signal. To be more specific, the residual signal encoding unit 130 obtains a sinusoidal signal by analyzing the residual signal, extracts components of the sinusoidal signal, and encodes the components. In this case, the residual signal may be encoded using a smaller bit, compared to a case in which the residual signal is directly encoded according to an Advanced Audio Coding (AAC) method, which is a parametric encoding method.

In this manner, according to the exemplary embodiment, by performing the parametric encoding method on the residual signal, the number of bits for encoding the residual signal may be reduced.

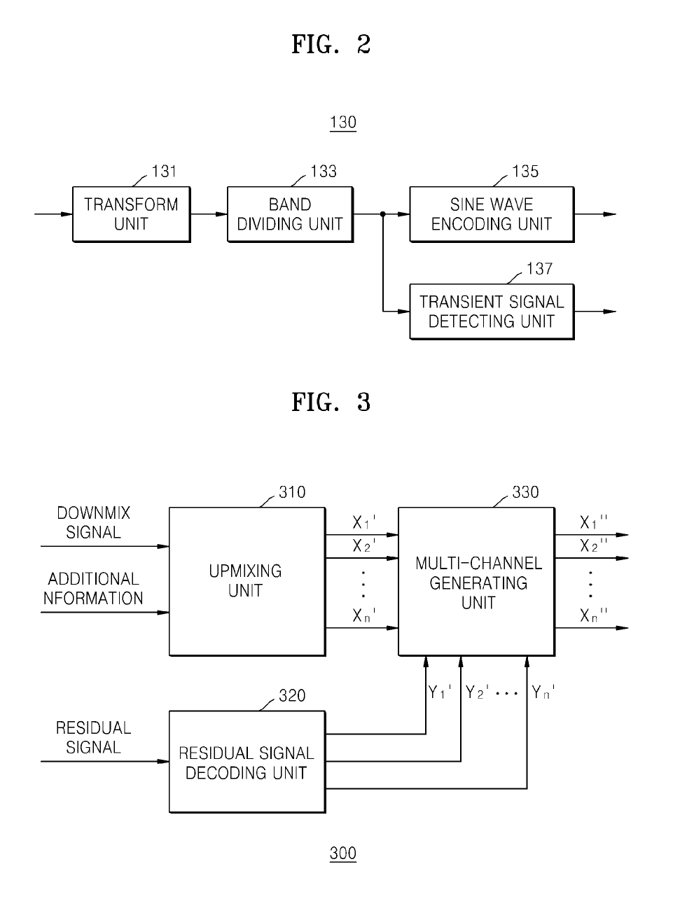

FIG. 2 is a block diagram of the residual signal encoding unit 130 shown in FIG. 1. Referring to FIG. 2, the residual signal encoding unit 130 includes a transform unit 131, a band dividing unit 133, a sine wave encoding unit 135, and a transient signal detecting unit 137.

The transform unit 131 transforms a residual signal into the frequency domain. The transform unit 131 may use, for example, a Quadrature Mirror Filterbank (QMF) or a Lapped Orthogonal Transform (LOT).

The band dividing unit 133 divides the residual signal into a plurality of sub-bands in the frequency domain.

The sine wave encoding unit 135 extracts and encodes a parameter with respect to the sinusoidal signals included in the residual signal. The sine wave encoding unit 135 performs sine wave analysis on a low frequency signal of a frequency equal to or less than a threshold frequency in the input residual signal, and thus extracts the sinusoidal signals. The threshold frequency may be predetermined, and may be set experimentally. The sinusoidal signals may be detected by using, for example, a Matching Pursuit (MP) method or a fast Fourier Transform (FFT) method.

The FFT method for detecting the sinusoidal signals involves performing fast Fourier Transform on an input low frequency signal, searching for each peak of sine waves having different frequencies, and detecting amplitude and phase of each sine wave. The MP method for detecting the sinusoidal signals involves searching for a fundamental frequency by using a pitch period, and scanning a sinusoidal component, i.e., a sinusoidal parameter, by using a sinusoidal dictionary. The sinusoidal dictionary may be predetermined. The sinusoidal component may include a frequency, a phase, or an amplitude, or some combination thereof. In addition to the aforementioned FFT method and MP method, by using various known sine wave extraction algorithms, sinusoidal signal components included in the low frequency signal equal to or less than the threshold frequency may be extracted.

The sine wave encoding unit 135 performs the sine wave analysis with respect to each sub-band so as to obtain a frequency, a phase, or an amplitude, or a combination thereof, of each sine wave, and encodes the obtained sinusoidal component.

The transient signal detecting unit 137 detects whether a sub-band including a transient signal is included in the divided sub-bands. The transient signal indicates a signal that varies abruptly during a short time period on a temporal axis. If a value of residual signal variation during a certain time period on the temporal axis is greater than a threshold value, the transient signal detecting unit 137 determines that the residual signal is a transient signal, and generates identification information for marking the sub-band including the transient signal. The time period may be predetermined. Hereinafter, the identification information for indicating the sub-band including the transient signal is referred to as transient information.

The residual signal encoding unit 130 transmits the encoded sinusoidal component and the encoded transient information along with or separately from the downmixed audio signal and the additional information to the audio signal decoding apparatus (not shown). The encoded sinusoidal component and the encoded transient information along with the downmixed audio signal and the additional information may be multiplexed into a bitstream and transmitted to the audio signal decoding apparatus.

In this manner, according to an exemplary embodiment, the residual signal encoding unit 130 generates the information about the sub-band including the transient signal, and transmits the information to the audio signal decoding apparatus, so that the residual signal encoding unit 130 may allow the audio signal decoding apparatus to detect the sub-band including the transient signal.

FIG. 3 is a block diagram of an audio signal decoding apparatus 300 according to another exemplary embodiment. Referring to FIG. 3, the audio signal decoding apparatus 300 includes an upmixing unit 310, a residual signal decoding unit 320, and a multi-channel generating unit 330. Although not illustrated in FIG. 3, the audio signal decoding apparatus 300 may further include an demultiplexing unit that parses an input bitstream, and a downmix signal decoding unit that decodes a downmix signal that is parsed from the bitstream. The demultiplexing unit parses the downmix signal, additional information, and a residual signal from the bitstream, and transmits the downmix signal and the residual signal respectively to the downmix signal decoding unit and the residual signal decoding unit 320. The downmix signal decoding unit decodes the parsed downmix signal, and transmits the decoded downmix signal to the upmixing unit 310.

The upmixing unit 310 upmixes the downmix signal by using the additional information. The upmixing unit 310 transmits a multi-channel audio signal that is generated by upmixing the decoded downmix signal to the multi-channel generating unit 330.

The residual signal decoding unit 320 decodes the parsed residual signal. To be more specific, the residual signal decoding unit 320 restores a sine wave by decoding an encoded sinusoidal component, and divides the sine wave into a plurality of sub-bands. The residual signal decoding unit 320 transforms signals of the sub-bands from the frequency domain into the time domain by applying a window to each sub-band, and generates the residual signal by synthesizing the transformed signals.

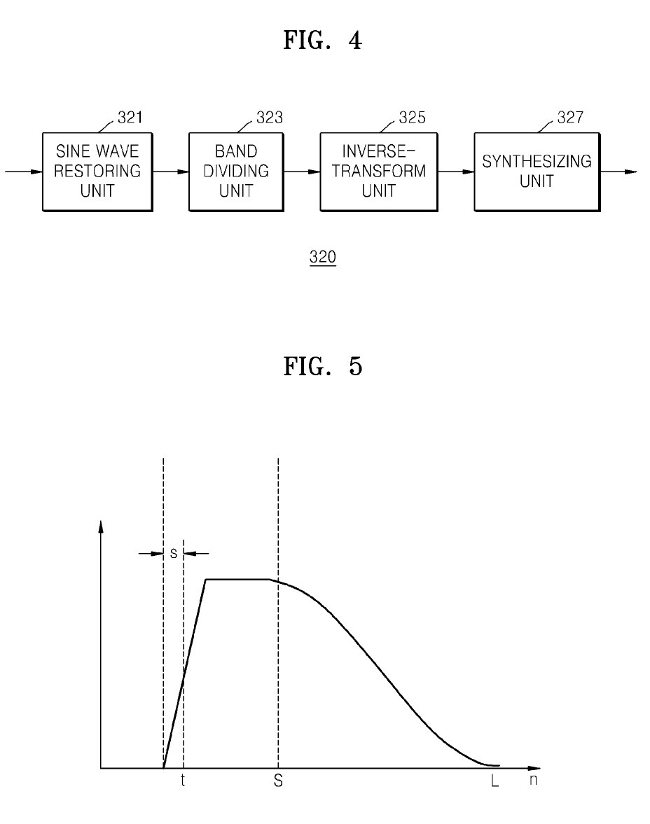

In the exemplary embodiment, when the residual signal decoding unit 320 applies the window to each sub-band, the residual signal decoding unit 320 may apply another window having a different size to a period in which a transient signal is generated. This will be described in detail with reference to FIG. 4.

The multi-channel generating unit 330 restores n multi channels by using the multi-channel audio signal generated by the upmixing unit 310, and the residual signal generated by the residual signal decoding unit 320.

In this manner, according to the exemplary embodiment, by performing a parametric encoding method on the residual signal, the residual signal may be restored by using a small bit.

FIG. 4 is a block diagram of the residual signal decoding unit 320 in FIG. 3. Referring to FIG. 4, the residual signal decoding unit 320 includes a sine wave restoring unit 321, a band dividing unit 323, an inverse-transform unit 325, and a synthesizing unit 327.

The sine wave restoring unit 321 decodes the encoded sinusoidal component. As described above, the sinusoidal component may include a frequency, a phase, or an amplitude, or a combination thereof, of a sinusoidal signal. The sine wave restoring unit 321 restores the sine wave by using the decoded sinusoidal component.

The band dividing unit 323 divides the sine wave into the plurality of sub-bands in the frequency domain, and the inverse-transform unit 325 applies the window to each sub-band and inverse-transforms the side-bands from the frequency domain to the time domain. For this, the inverse-transform unit 325, for example, averages the residual signal with a time unit, and thus obtains a frequency component of an averaged signal. The time unit may be predetermined.

In the case where the residual signal includes a transient signal, if the transient signal is averaged, an overall energy level is significantly different from an energy level of a general residual signal, and thus a characteristic of a signal becomes different.

In order to prevent this, according to the exemplary embodiment, the inverse-transform unit 325 may apply a transient signal window to the sub-band including the transient signal, and thus may perform a domain transform. That is, the inverse-transform unit 325 may prevent a pre-echo from occurring by applying the transient signal window to the sub-band including the transient signal, wherein the transient signal window has a size smaller than a size of the window that is applied to other sub-bands.

It is assumed that the nₜₕ sub-band from among the plurality of sub-bands includes the transient signal. In this case, if a window having a size which is applied to other sub-bands is used for the nₜₕ sub-band, the window applied to the nₜₕ sub-band is overlapped with the window applied to the n−1ₜₕ sub-band and the window applied to the n+1ₜₕ sub-band, such that the transient signal included in the nₜₕ sub-band makes quantum noise in another sub-band. To prevent this, according to the exemplary embodiment, the transient signal window is applied to the sub-band including the transient signal, wherein a length of the transient signal window is shorter than that of a window applied to other sub-bands. In the above case, if the transient signal window is applied to the nₜₕ sub-band, it is possible to prevent the quantum noise from affecting the n−1ₜₕ sub-band and the n+1ₜₕ sub-band.

The inverse-transform unit 325 may use transient information so as to detect the sub-band including the transient signal. That is, the inverse-transform unit 325 may, for example, use the transient information received from the residual signal processing device 100 in FIG. 1 so as to detect the sub-band to which the transient signal window is to be applied. In general, since a sinusoidal component of a high frequency having a short wavelength includes a transient signal, the inverse-transform unit 325 applies the transient signal window to a high frequency included in a sub-band that is detected by using the transient information.

The synthesizing unit 327 synthesizes signals of the domain-transformed sub-bands, and thus restores the residual signal.

In this manner, according to the exemplary embodiment, when the parametric coding method is applied to the residual signal, the transient signal window is applied to a period in which the transient signal is generated, so that it is possible to prevent the pre-echo from occurring.

FIG. 5 is a diagram of a transient signal window according to another exemplary embodiment. Referring to FIG. 5, it is apparent that a residual signal includes a transient signal that is generated at a point of time t. In this case, the transient signal window w[n] to be applied to the transient signal is expressed in the following manner.

w[n]=0, 0≦n<t−s,

w[n]=(n−t+s+1)/(2*(s+1)), t−s≦n≦t+s,

w[n]=1, t+s<n<S,

w[n]=1/2−1/2 cos {Π*(2n+1)/L}, S≦n<L

where, n indicates a unit on an X-axis, that is, n indicates a sub-band, and s indicates a length between a point of time at which a current sub-band starts and a point of time at which the transient signal is generated. S indicates a boundary point between the current sub-band in which the transient signal is generated and a next sub-band, and L indicates a random point of time on the X-axis.

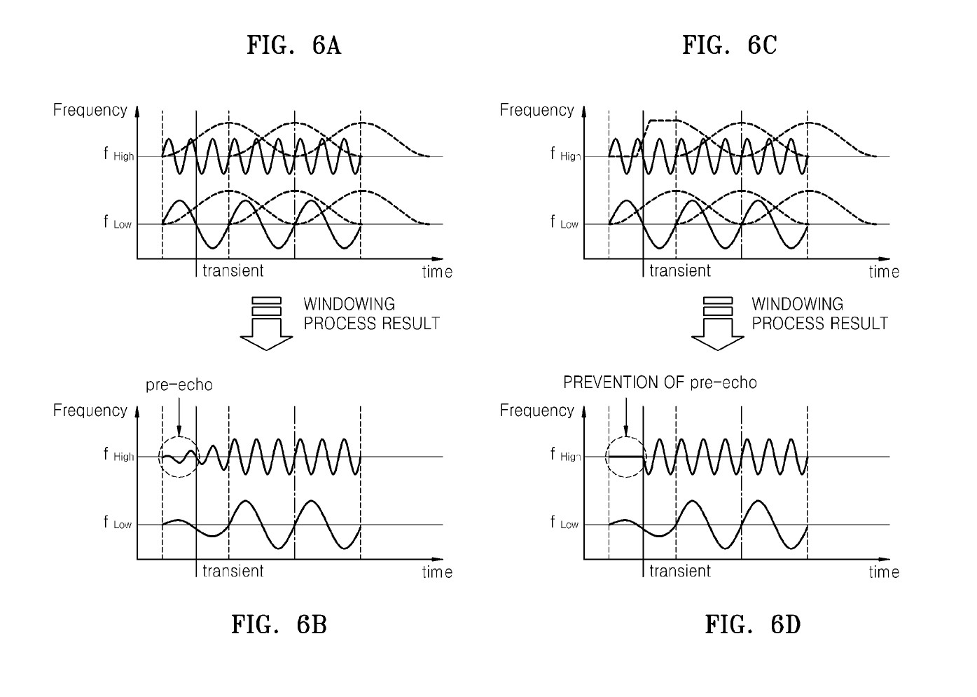

FIGS. 6A through D are diagrams illustrating a case in which a pre-eco does not occur when a domain-transform is performed by applying the transient signal window according to an exemplary embodiment.

FIGS. 6A and B correspond to a case in which, although a transient signal is generated at a point of time on a temporal axis, a normal size window is applied to a sub-band including the transient signal. As shown in FIG. 6A, in the case where a windowing process is performed, as shown in FIG. 6B, it is possible to see that a pre-echo occurs at a high frequency around a point of time at which the transient signal is generated.

FIGS. 6C and D correspond to a case in which, when a transient signal is generated at a point of time on a temporal axis, a transient signal window other than a normal size window is applied to a sub-band including the transient signal according to the current exemplary embodiment.

Referring to FIG. 6C, it is possible to see that the transient signal window having the same shape as that in FIG. 5 is applied to a high frequency with respect to the sub-band including the transient signal. In this case, as shown in FIG. 6D, it is possible to see that a pre-echo does not occur at the high frequency around a point of time at which the transient signal is generated.

In this manner, according to the current exemplary embodiment, when decoding is performed on the residual signal, by applying the transient signal window to the point of time at which the transient signal is generated, it is possible to prevent the pre-echo from occurring.

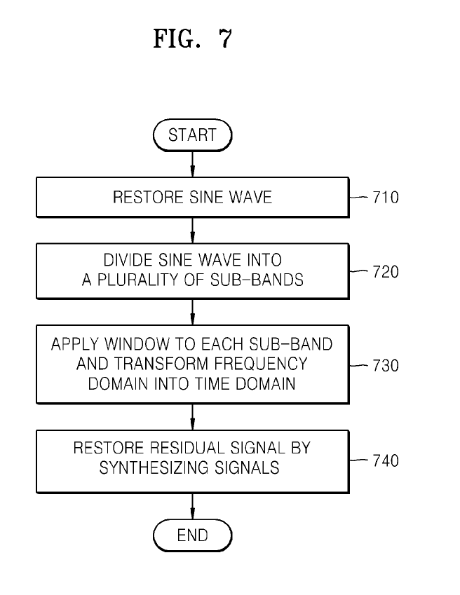

FIG. 7 is a flowchart of a residual signal decoding method, according an exemplary embodiment. Referring to FIG. 7, the audio signal decoding apparatus 300 decodes a sinusoidal component that is parametric-encoded with respect to a residual signal, and restores a sine wave by using the decoded sinusoidal component (operation 710). The audio signal decoding apparatus 300 divides the sine wave into a plurality of sub-bands in a frequency domain (operation 720).

The audio signal decoding apparatus 300 applies a window to each sub-band, and thus transforms the frequency domain into a time domain (operation 730). In this case, the audio signal decoding apparatus 300 may apply a transient signal window to the sub-band including the transient signal. The audio signal decoding apparatus 300 may receive information indicating the sub-band including the transient signal from the residual signal processing device 100, and may identify the sub-band including the transient signal by using the information.

The audio signal decoding apparatus 300 restores the residual signal by synthesizing signals of the domain-transformed sub-bands (operation 740).

In the related art, transform coding has been performed during high sound multi-channel encoding. However, in these cases in the related art, the residual signals are very small or have no significance during transform encoding, and thus, parametric encoding has not been performed with residual signals. When parametric encoding is performed with multi-channels as described above, since the audio signals are encoded using a very small amount of bits, the residual signals contain a greater amount of effective information to be encoded, and thus, parametric encoding is performed with the residual signals.

The residual signal encoding and decoding method and apparatus according to exemplary embodiments may also be embodied as computer readable codes on a computer readable medium. The computer readable medium may be a computer readable storage medium or a computer readable transitory medium. The computer readable storage medium is any data storage device that can store data which can be thereafter read by a computer system. Non-limiting examples of the computer readable storage medium include read-only memory (ROM), random-access memory (RAM), CD-ROMs, DVDs, magnetic tapes, floppy disks, optical data storage devices, etc. The computer readable storage medium can also be distributed over network coupled computer systems so that the computer readable code is stored and executed in a distributed fashion. The computer readable transitory medium includes carrier signals or transmission using carrier signals. Non-limiting examples of the computer readable transmission medium include AM or FM radio transmissions, spread spectrum transmissions, or transmissions using a carrier signal of any frequency or using any communications coding system. Also, functional programs, codes, and code segments for accomplishing the exemplary embodiments can be easily construed by programmers of ordinary skill in the art to which the present invention pertains.

While exemplary embodiments have been particularly shown and described, it will be understood by those of ordinary skill in the art that various changes in form and details may be made therein without departing from the spirit and scope of the present invention as defined by the following claims.

What is claimed is:

1. A residual signal encoding method comprising:
generating a residual signal indicating a difference between a multi-channel audio signal, and an audio signal downmixed from the multi-channel audio signal and then upmixed by using additional information from the downmixed audio signal; and
performing a parametric encoding method on the residual signal.

2. The residual signal encoding method of claim 1, wherein the performing of the parametric encoding method comprises:
obtaining a sinusoidal component of the residual signal; and
encoding the sinusoidal component.

3. The residual signal encoding method of claim 2, wherein the obtaining of the sinusoidal component comprises:
transforming the residual signal into a frequency domain;
dividing the residual signal into a plurality of sub-bands; and
obtaining the sinusoidal component with respect to the residual signal in the frequency domain.

4. The residual signal encoding method of claim 3, further comprising:
detecting whether a sub-band including a transient signal exists in the plurality of sub-bands; and
if a sub-band comprising a transient signal exists, generating transient information for identifying the sub-band that includes the transient signal.

5. A residual signal decoding method comprising:
decoding a sinusoidal component;
restoring a sine wave by using the sinusoidal component;
dividing the sine wave into a plurality of sub-bands in a frequency domain;
transforming the plurality of sub-bands from the frequency domain into a time domain by applying a window to each of the plurality of sub-bands; and
synthesizing the plurality of domain-transformed sub-bands to restore a residual signal.

6. The residual signal decoding method of claim 5, wherein the transforming the plurality of sub-bands comprises applying a transient signal window to a sub-band that includes a transient signal.

7. The residual signal decoding method of claim 6, wherein the transforming the plurality of sub-bands further comprises identifying a sub-band that includes a transient signal by using transient information that indicates the sub-band that includes the transient signal.

8. The residual signal decoding method of claim 5, wherein the sinusoidal component comprises an amplitude, a phase, or a frequency, or a combination thereof, of the sine wave.

9. A residual signal encoding apparatus comprising:
a residual signal generating unit that generates a residual signal indicating a difference between a multi-channel audio signal, and an audio signal downmixed from the multi-channel audio signal and then upmixed by using additional information from the downmixed audio signal; and
a residual signal encoding unit that performs a parametric encoding method on the residual signal.

10. The residual signal encoding apparatus of claim 9, wherein the residual signal encoding unit obtains a sinusoidal component of the residual signal, and encodes the sinusoidal component.

11. The residual signal encoding apparatus of claim 10, wherein the residual signal encoding unit comprises:
a transform unit that transforms the residual signal into the frequency domain;
a band dividing unit that divides the residual signal into a plurality of sub-bands in the frequency domain; and
a sine wave encoding unit that obtains the sinusoidal component, and encodes the sinusoidal component.

12. The residual signal encoding apparatus of claim 11, further comprising a transient signal detecting unit that detects whether a sub-band that includes a transient signal exists in the plurality of sub-bands, and if a sub-band that includes the transient signal exists, generates transient information for identifying the sub-band that includes the transient signal.

13. A residual signal decoding apparatus comprising:
a sine wave restoring unit that decodes a sinusoidal component, and restores a sine wave by using the sinusoidal component;
a band dividing unit that divides the sine wave into a plurality of sub-bands in the frequency domain;
an inverse-transform unit that transforms the plurality of sub-bands from the frequency domain into the time domain by applying a first window to each of the plurality of sub-bands; and
a synthesizing unit that synthesizes the plurality of domain-transformed sub-bands to restore a residual signal.

14. The residual signal decoding apparatus of claim 13, wherein the inverse-transform unit applies a transient signal window to a sub-band that includes a transient signal.

15. The residual signal decoding apparatus of claim 14, wherein the inverse-transform unit identifies the sub-band that includes the transient signal by using transient information that indicates the sub-band that includes the transient signal.

16. The residual signal decoding apparatus of claim 13, wherein the sinusoidal component comprises an amplitude, a phase, or a frequency, or a combination thereof, of the sine wave.

17. A computer readable medium having recorded thereon a program for executing a residual signal encoding method comprising:
generating a residual signal indicating a difference between a multi-channel audio signal, and an audio signal downmixed from the multi-channel audio signal and then upmixed by using additional information from the downmixed audio signal; and
performing a parametric encoding method on the residual signal.

18. A computer readable medium having recorded thereon a program for executing a residual signal decoding method comprising:
decoding a sinusoidal component;
restoring a sine wave by using the sinusoidal component;
dividing the sine wave into a plurality of sub-bands in the frequency domain;
transforming the plurality of sub-bands from the frequency domain to the time domain by applying a window to each of the plurality of sub-bands; and
synthesizing the plurality of domain-transformed sub-bands to restore a residual signal.

19. An encoding method comprising:
generating a residual signal from a multi-channel audio signal; and
parametrically encoding the residual signal.

20. The encoding method of claim 19, further comprising encoding the multi-channel audio signal,
wherein the multi-channel audio signal is encoded using a non-parametric encoding method.

21. The encoding method of claim 19, further comprising encoding the multi-channel audio signal,
wherein the multi-channel audio signal is encoded using a parametric encoding method.

22. The encoding method of claim 19, wherein parametrically encoding the residual signal comprises:
determining whether a transient signal is included in the residual signal; and
if a transient signal is identified in the residual signal, generating transient information identifying the transient signal, and transmitting the transient information.

23. The encoding method of claim 22, wherein the determining operation comprises:
determining whether a sub-band of the residual signal includes the transient signal,
wherein the transient information indicates the sub-band of the residual signal that includes the transient signal.

24. A decoding method comprising:
decoding an encoded residual signal that corresponds to a downmix signal; and
decoding the downmix signal into a multi-channel audio signal using the decoded residual signal.

25. The decoding method according to claim 24, wherein the decoding the encoded residual signal operation comprises:
dividing the encoded residual signal into a plurality of sub-bands;
transforming the sub-bands from the frequency domain to the time domain using a first window; and
synthesizing the transformed sub-bands into the decoded residual signal.

26. The decoding method according to claim 25, wherein the transforming operation further comprises using a second window having a size smaller than a size of the first window.
